(19) United States
(12) Patent Application Publication
(10) Pub. No.: US 2007/0128567 A1
(43) Pub. Date: Jun. 7, 2007

(54) Device for positioning the conveyor belt running through machines for thermal treatment of filaments

(75) Inventors: Philippe Massotte, Gueberschwihr (FR); Michel Mazoyer, Pfastatt (FR); Serge Munschi, Rantzwiller (FR)

Correspondence Address: YOUNG & THOMPSON, 745 SOUTH 23RD STREET, 2ND FLOOR, ARLINGTON, VA, 22202, US

(73) Assignee: SUPERBA, MULHOUSE (FR)

(21) Appl. No.: 11/603,125

(22) Filed: Nov. 22, 2006

(30) Foreign Application Priority Data
Dec. 2, 2005 (FR) 05 53695

(51) Int. Cl. B01J 3/04

(52) U.S. Cl. 432/120

(57) ABSTRACT

The present relates to a device for positioning the conveyor belt running through machines for thermal treatment of filaments, essentially constituted by a pressurized chamber (1) traversed by a conveyor belt (2) enclosed at each end by a sealing head mounted on a frame or movable door (3) connected to the pressurized chamber (1) by means of a bellows (4), each sealing head comprising a head of horizontal superposed rollers (5, 6) which are pressed against the opposite surfaces of the conveyor belt (2).

Device characterized in that it comprises a positioning means (8) and a position control means (9) acting on a very short region immediately adjacent each sealing head. The invention is more particularly applicable in the field of the textile industry, in particular of the field of treating filaments by means of thermal treatment machines currently called heat setting machines.

The present invention relates to the field of the textile industry, in particular the treatment of filaments by means of thermal treatment machines presently called heat setting machines, and has for its object a device for positioning the conveyor belt that runs through such machines.

Thermal treatment machines are essentially constituted by a pressurized thermal treatment chamber for textile filaments disposed on a conveyor belt passing through said chamber, which is closed at its two ends by sealing heads each comprising a frame or movable door fixed to the pressurized chamber, a pair of horizontal superposed rollers which are pressed against opposite surfaces of the conveyor belt, and sealing means to form a sealed closure between the rollers and the frame.

The horizontal rollers are actuated by gripping means permitting movement of at least one of the rollers in one direction or the other, for gripping against the conveyor belt. Moreover, the sealing heads are mounted, each by means of its frame or movable door, in a pivotal manner relative to a medial vertical axis and are connected to the treatment chamber by means of a bellows extending between the vertical pivotal axis and the frame or movable door of said sealing heads.

In the course of operation, the conveyor belt can be subjected to a deviation between the inlet and the outlet of the thermal treatment machine, which deviation has the risk of giving rise, in the case of exceeding a predetermined limit, to the risk catching within the interior of the machine, which could give rise at least to stopping the machine to take care of the problem, even to damage.

At present, this problem is solved by the provision of the positioning of the conveyor belt between the inlet and outlet heads by means of cells for detecting the position of said belt at the ends of the machine, which is to say near the sealing heads, these detection cells delivering a control signal for modification of the position of the heads by means of actuators acting on the frame or movable door of these latter to cause their pivoting. Such pivoting of the sealing heads has the effect of modifying the position of the axis of the sealing rollers, such that the conveyor belt is corrected in the opposite direction from the deviation in question, this because of the gripping of the conveyor belt between the superposed horizontal rollers. Thus, during pivoting of the sealing head, the conveyor belt is driven pivotally, because of its gripping between the longitudinal rollers, along a transverse generatrix, which causes corresponding correction of this latter, so as to correct its deviation and to return it to its normal surface position.

Generally, the means for detection and correction of the position of the conveyor belt of such machines are quite suitable to ensure good positioning of said conveyor belt. However, there arises the problem of detection and hence of correction of the deviation when the conveyor belt, because of its aging, becomes incurved. Indeed, the position detectors for the conveyor belt at the inlet and outlet of the machine are sensitive to the deformation of this conveyor belt.

Moreover, because of the mounting of the frames or movable doors of the sealing heads, each on a vertical pivotal axle provided remote from said frames or movable doors of the sealing heads, it is necessary to take account in an anticipated manner, of the pivoting of said sealing heads, which is increased by the effect of a lever arm effect due to the distance between the pivotal axis and the plane of the horizontal superposed rollers and the distance between the detectors and the heads, giving rise to amplification of the deviation in question.

Moreover, the mounting of the sealing heads in the manner described above gives rise to an important overhang of the heads and hence of the corresponding stresses on the pivotal axis, requiring corresponding dimensioning of the assembly of the mounting elements of said heads.

The present invention has for its object to overcome these drawbacks by proposing a positioning device for the conveyor belt running through thermal treatment machines for filaments, permitting controlling and correcting continuously the deviation of said conveyor belt, whilst limiting the amplitude of the movements of the sealing heads.

To this end, the positioning device for the conveyor belt according to the invention, adapted to equip thermal treatment machines of filaments, essentially constituted by a pressurized chamber traversed by the conveyor belt and closed at each end by a sealing head mounted on a frame or movable door connected to the pressurized chamber by means of a bellows, each sealing head comprising a pair of horizontal superposed rollers which are pressed against opposite surface of the conveyor belt, is characterized in that it comprises a positioning means and a means for controlling the position acting on a very short region immediately adjacent each sealing head.

The invention will be better understood from the following description, which relates to preferred embodiments, given by way of non-limiting examples, and explained with reference to the accompanying schematic drawings, in which:

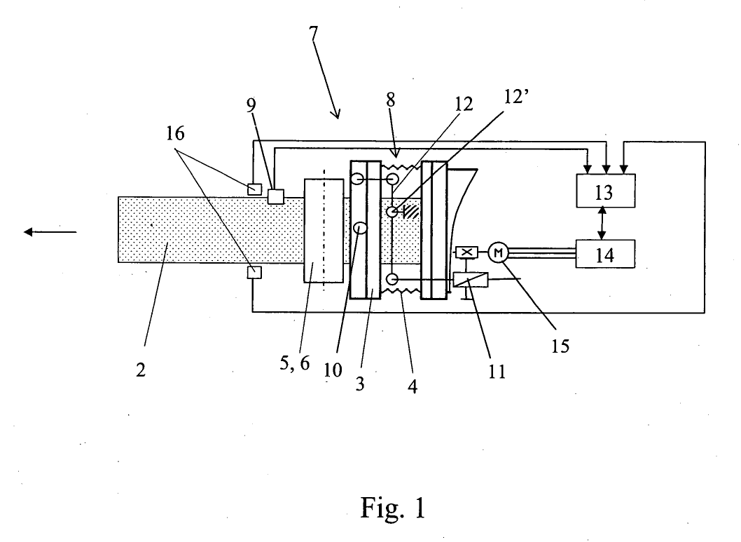

FIG. 1 is a fragmentary plan and cross-sectional view of a thermal treatment machine for filaments equipped with the device according to the invention;

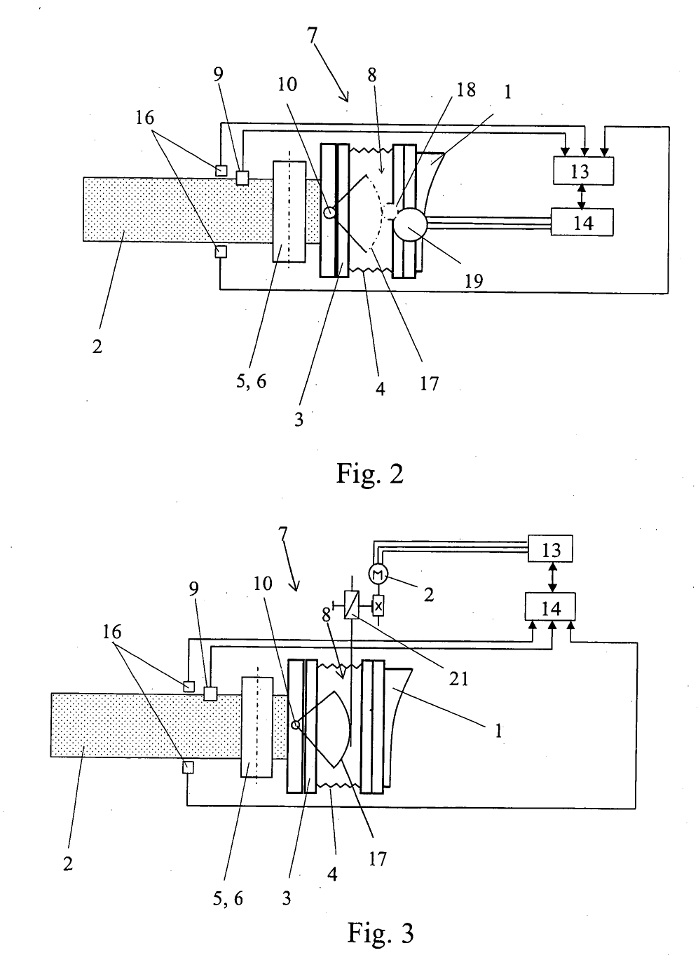

FIGS. 2 and 3 are views analogous to that of FIG. 1 of modified embodiments of the invention;

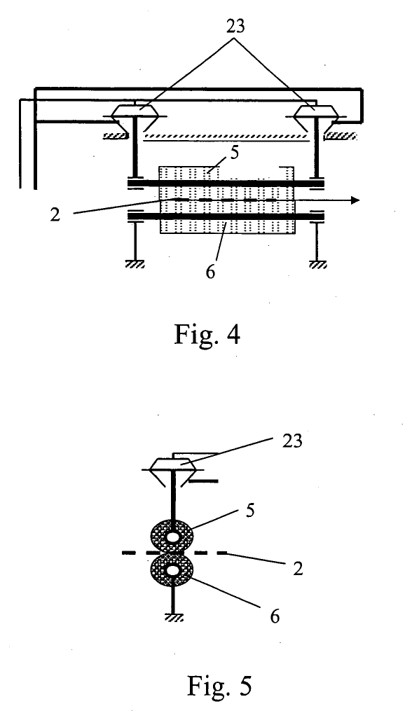

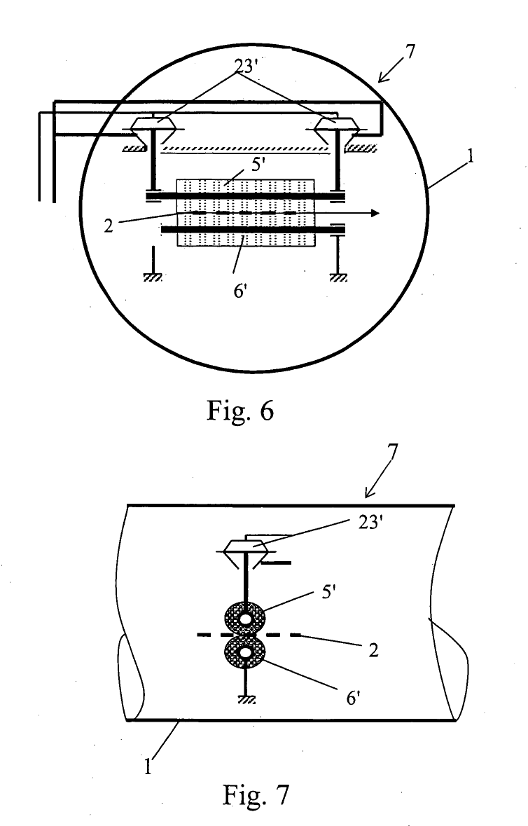

FIGS. 4 and 5 are cross-sectional views, respectively in front elevation and in side elevation, of another modified embodiment of the invention, and FIGS. 6 and 7 are views analogous to those of FIGS. 4 and 5, of another modified embodiment of the invention.

FIG. 1 of the accompanying drawings shows, by way of example, a machine for the thermal treatment of filaments, essentially constituted by a pressurized chamber 1 traversed by a conveyor belt 2 and closed at each end by a sealing head mounted on a frame or movable door 3 connected to the pressurized chamber 1 by means of a bellows 4, each sealing head comprising a pair of horizontal superposed rollers 5, 6 which are pressed against opposite surfaces of the conveyor belt 2. So as to avoid inadmissible deviation of the conveyor belt, this thermal treatment machine for filaments is provided with a positioning device 7 for this belt. In FIGS. 1 to 3 of the accompanying drawings, only one end of a thermal treatment machine for filaments is shown in cross-sectional and plan view, such that only one roller of the pair of rollers 5 and 6 forming the sealing head is visible. Moreover, it is clear that the end (not shown) of the thermal treatment machine for filaments is present in a symmetrical manner to that shown on said accompanying drawings.

According to the invention, and as shown by way of example in FIGS. 1 to 3 of the accompanying drawings, the positioning device 7 comprises a positioning means 8 and a position control means 9 acting on a very short region immediately adjacent each sealing head.

The positioning means 8 consists, according to the preferred embodiment of FIG. 1, in a pivotal axle 10 for the frame or movable door 3 directly secured with said frame or movable door 3, and an actuator 11 for pivoting of the frame or movable door 3 by means of links 12 mounted on the edge of the frame or movable door 3 and said actuator 11. This latter is preferably constituted in the form of a screw jack.

Thus, it is possible to carry out pivoting of very small amplitude of the frame or movable door 3, such that sealing head constituted by the rollers 5 and 6 is pivoted about its pivotal axle 10 and gives rise to movement of the conveyor belt 2 in a direction opposite the deviation in question.

The position control means 9 is constituted by at least one position detector disposed adjacent at least one edge of the conveyor belt 2, adjacent the superposed horizontal rollers 5 and 6 of the sealing head, this detector being a proportional analog detector connected to a computer control means 13 delivering a correction signal to a servo-inverter 14 for controlling a motor 15 for driving the actuator 11 constituting the positioning means 8 for the frame or movable door 3.

Preferably, the detector forming the position control means 9 is an optical detector extending on both sides of an edge of the conveyor belt 2. However, it is also possible to provide the detector forming the position control means 9 in the form of a pneumatic detector, an eddy current detector of a feeler. The operation of such detectors is known to those skilled in the art and will not be described in detail.

Moreover, the position control means 9 can be completed by a safety device consisting in detection cells 16 extending laterally on opposite sides of the conveyor belt 2 upstream or downstream of the detector forming the position control means 9, these detection cells 16 being adapted to be of the same type as this latter.

According to another characteristic of the invention, the computer means 13 for the positioning means 8 and for the position control means 9 of the sealing heads of the two ends of the machine for the thermal treatment of filaments, are preferably interconnected and the positioning means 8 for the frame or movable door 3 are disposed in an inverse manner so as to carry out movement in the identical direction for the two sealing heads. Thus, upon detection of a deviation of the conveyor belt at one or the other end of the machine for the thermal treatment of filaments, it is necessary to correct said conveyor belt 2 so as to center it perfectly within the machine for the treatment of filaments and the correction of deviation necessary at one end must automatically be carried back to the other end, at least as to its direction.

In the operation of the thermal treatment machine, the belt 2 passes in the longitudinal direction of the treatment line, passing through said machine and, when the belt deviates from its path to the left or to the right, its deviation is measured adjacent the sealing head by the position control means 9, which transmits the relevant data to the computing means 13. When a deflection greater than a maximum permissible value is detected, the computing means 13 determines a deviation correction to be carried out and delivers a corresponding control signal to the servo-inverter 14 for controlling the motor 15 for actuating the screw jack 11. This latter thus drives the links 12 with a pivotal movement about an axle 12′ having the effect of giving rise to corresponding pivoting of the frame or movable door 3 about the axle 10 and thus a corresponding angular movement of the sealing head. It follows that the rollers 5, 6 of this latter, which grip between them the conveyor belt 2, shifting of said conveyor belt 2 corresponding to the pivotal direction of the sealing head and of the frame or movable door 3. The conveyor belt 2 is thus returned to a normal direction of movement within the permitted tolerances.

According to a modified embodiment of the invention, shown in FIG. 2 of the accompanying drawings, the actuator for pivoting the frame or movable door 3 can also act directly on said frame or movable door 3 and is constituted for this purpose by a toothed sector 17 secured at one end to said frame or movable door 3 and by a pinion 18 engaging with said toothed sector 17 and driven by a stepping motor 19 controlled by means of the servo-inverter 14. In such a case, the elements for transmission of the pivotal movement of the frame or movable door 3 are limited to a minimum, which has the result of reducing the risk of mechanical accident, as well as maintenance work.

It is also possible, according to another modified embodiment of the invention, shown in FIG. 3 of the accompanying drawings, to constitute the pivotal actuator of the frame or movable door 3 in the form of a toothed sector 17 secured at one end to said frame or movable door 3 and by a rack 20 engaging with said toothed sector 17 and driven by a screw jack 21, whose motor 22 is controlled by means of a servo-inverter 14. This embodiment permits obtaining results and advantages comparable to those obtained by means of the device according to FIG. 2.

According to another modified embodiment of the invention, and as shown in FIGS. 4 and 5 of the accompanying drawings, the positioning means 8 can be formed directly by the horizontal roller 5, 6 of the sealing heads, by means of one of these rollers being able to apply different pressure at its ends to the conveyor belt 2, for example individual control of actuators 23 for applying pressure to the ends of these rollers. Thus, it is possible, by a separate and controlled command of the application pressure of the rollers 5, 6 against the conveyor belt 2, to carry out a greater pressure at one end of the rollers, for example on the left side (FIGS. 4 and 5), which has the effect of urging the corresponding edge of the conveyor belt 2 toward the end of the rollers subjected to lesser pressure, namely to the right, as shown by the arrow (FIG. 4), such that the detected deviation can be rapidly and easily corrected.

It is also possible, according to another modified embodiment of the invention, shown in FIGS. 6 and 7 of the accompanying drawings, to make the positioning device 7 in the form of an assembly comprising a single positioning means disposed within the chamber 1 of the machine for thermal processing of filaments, and position control means 9 acting immediately adjacent each sealing head. In such a case, the single positioning means can be in the form of two rollers 5′, 6′, disposed within the processing chamber 1, substantially at the middle of this latter, and gripped on opposite sides against the conveyor belt 2, in the manner of the horizontal rollers 5 and 6 of the sealing heads, the gripping of the ends of these rollers 5′, 6′ in the direction of the conveyor belt 2 being carried out independently and in a controlled manner by means of actuating jacks 23′. In such an embodiment, which corresponds in its construction to that described above with respect to the sealing heads according to FIGS. 4 and 5, the correction of the conveyor belt 2 by shifting can also be carried out by application of a greater driving pressure against one edge of the conveyor belt, such that the latter is automatically corrected in the opposite direction. Thus, the increase of the pressure of the rollers on one edge of the conveyor belt gives rise to an increased driving effect of said edge or an effect of relative sliding of the other edge, such that the conveyor belt 2 has the natural tendency to undergo modification of its alignment.

An embodiment of a thermal treating machine for filaments according to the two latter modes of embodiment set forth, permits modifying considerably the construction even of the machine for thermal treatment, because of the fact that the frame or movable door 3 can be replaced by a fixed device for closing the ends of the treatment chamber, of simpler construction and requiring no bellows at the junction with said chamber.

Thanks to the invention, it is possible to control perfectly the deviation of a conveyor belt, whether the latter is entirely new and straight or used and having deformations such as a dip or undulations, by continuous correction of such diversion. This correction is preferably carried out by providing micro-pivotings of the frame or movable door 3, no matter what the speed of movement of the belt and if desired also when this latter is subjected to reverse movements of relatively short length.

This limitation of the deviations is essentially due to the limitation, even the suppression of the lever arm effect of the mounting of the frame or movable door 3. Moreover, this simplified mounting of this frame or movable door 3 has the advantage of a simpler construction of the machine.

The invention thus permits perfectly positioning, over a predetermined portion of its length, a conveyor belt 2 of great length, continuously moving in a plane. Thus, the correction of the deviation of the conveyor belt 2 is carried out without changing the direction of the belt outside the plane by return roller means or the like, as is conventional, for example for the guidance of moving bands.

Of course, the invention is not limited to the embodiment described and shown in the accompanying drawings. Modifications remain possible, particularly as to the construction of the various elements or by substitution of technical equivalents, without thereby departing from the scope of protection of the invention.

1. Device for positioning the conveyor belt moving in thermal treatment machines for filaments, essentially constituted by a pressurized chamber (1) traversed by a conveyor belt (2) and closed at each end by a sealing head mounted on a frame or movable door (3) connected to the pressurized chamber (1) by means of a bellows (4), each sealing head comprising a pair of superposed horizontal rollers (5, 6) which are pressed against opposite surfaces of the conveyor belt (2), characterized in that it comprises positioning means (8) and position control means (9) acting on a very short region immediately adjacent each sealing head.

2. Device according to claim 1, characterized in that the positioning means (8) consists of a pivotal axle (10) for the frame or movable door (3) secured directly to said frame or movable door (3), and an actuator (11) for pivoting said frame or movable door (3).

3. Device according to claim 2, characterized in that the actuator (11) acts on the frame or movable door (3) by means of links (12) mounted between the edge of the frame or movable door (3) and said actuator (11).

4. Device according to claim 2, characterized in that the actuator (11) is constituted by a screw jack.

5. Device according to claim 1, characterized in that the position control means (9) is constituted by a position detecting means disposed adjacent at least one edge of the conveyor belt (2), adjacent the superposed horizontal rollers (5 and 6) of the sealing head, this detector being a proportional analog detector connected to computer means (13) comprising a correction signal to a servo-inverter (14) for controlling a drive motor (15) of the actuator (11) constituting positioning means (8) of the frame or movable door (3).

6. Device according to claim 5, characterized in that the detector forming the position control means (9) is an optical detector extending on opposite sides of an edge of the conveyor belt (2).

7. Device according to claim 5, characterized in that the detector forming the position control means (9) is in the form of a pneumatic detector, an eddy current detector, or a feeler.

8. Device according to claim 5, characterized in that the position control means (9) is completed by a safety device consisting of detection cells (16) extending laterally on opposite sides of the conveyor belt (2) upstream or downstream of the detector forming the positioning control means (9), these detection cells (16) being of the same type as this latter.

9. Device according to claim 1, characterized in that the computing means (13) of the positioning means (8) and position control means (9) of the sealing heads of the two ends of the machines for thermal treatment of filaments, are interconnected and the positioning means (8) of the frame or movable door (3) are disposed in reverse manner so as to provide movement in an identical direction of the two sealing heads.

10. Device according to claim 2, characterized in that the actuator for pivoting the frame or movable door (3) acts directly on said frame or movable door (3) and is constituted by a toothed sector (17) secured at one end to said frame or movable door (3) and by a pinion (18) engaging with said toothed sector (17) and driven by a stepping motor (19) controlled by means of a servo-inverter (14).

11. Device according to claim 2, characterized in that the actuator for pivoting of the frame or movable door (3) acts directly on said frame or movable door (3) and is constituted by a toothed sector (17) secured at one end to said frame or movable door (3) and by a rack (20) engaging with said toothed sector (17) and driven by a screw jack (21), whose motor (22) is controlled by servo-inverter means (14).

12. Device according to claim 1, characterized in that the positioning movement (8) of each sealing head is effected directly by the horizontal rollers (5, 6) of said sealing head, at least one of these rollers being adaptive at its ends with different pressure application to the conveyor belt (2), under the control of individual actuators (23) for pressing the ends of these rollers.

13. Device according to claim 1, characterized in that the positioning device (7) is in the form of an assembly comprising a single positioning means disposed within the chamber (1) of the thermal processing machine for filaments, and position control means (9) disposed immediately adjacent each sealing head.

14. Device according to claim 13, characterized in that the single positioning means (7) is in the form of two rollers (5′, 6′) disposed within the treatment chamber (1), substantially in the middle of the latter, and gripped on opposite sides against the conveyor belt (2), in the manner of horizontal rollers (5 and 6) of the sealing heads, the gripping of the ends of these rollers (5′, 6′) in the direction of the conveyor belt (2) being carried out independently of the manner of control of the actuating means (23′).
